(19) United States
(12) Patent Application Publication
(10) Pub. No.: US 2025/0074804 A1
(43) Pub. Date: Mar. 6, 2025

(54) METHOD AND APPARATUS FOR TREATING WASTEWATER

(71) Applicants: Samsung E&A Co., Ltd., Seoul (KR); Samsung Electronics Co., Ltd., Suwon (KR)

(72) Inventors: Soo Jin SHIM, Gyeonggi-do (KR); Hye Sook SUNG, Seoul (KR); Jeong Su CHO, Seoul (KR); Seung Joon CHUNG, Suwon-si (KR); Jae Dong HWANG, Seoul (KR); Hyeon Seok KANG, Gyeonggi-do (KR); Je Hun KIM, Gyeonggi-do (KR); Chang Hyun NAHM, Gyeonggi-do (KR)

(73) Assignees: Samsung E&A Co., Ltd., Seoul (KR); Samsung Electronics Co., Ltd., Suwon (KR)

(21) Appl. No.: 18/743,311

(22) Filed: Jun. 14, 2024

(30) Foreign Application Priority Data
Sep. 4, 2023 (KR) 10-2023-0117219

(51) Int. Cl. C02F 9/00; B01D 21/00; B01D 21/01; B01D 21/08; C02F 1/00; C02F 1/52; C02F 1/56; C02F 1/66; C02F 101/10; C02F 101/14

(52) U.S. Cl. CPC C02F 9/00; B01D 21/003; B01D 21/01; B01D 21/08; C02F 2001/007; C02F 1/5245; C02F 1/5272; C02F 1/56; C02F 1/66; C02F 2101/105; C02F 2101/14; C02F 2301/08

(57) ABSTRACT

The method for treating wastewater includes a first flocculation-and-sedimentation process and a second flocculation-and-sedimentation process, wherein the first flocculation-and-sedimentation process include: passing wastewater through a first flocculation reaction tank; passing the first treated water through a third flocculation reaction tank; passing the third treated water through a fourth flocculation reaction tank; and passing the fourth treated water through a first sedimentation tank to generate fifth treated water and sludge, and the second flocculation-and-sedimentation process include: passing the fifth treated water through a fifth flocculation reaction tank to generate sixth treated water; passing the sixth treated water through a sixth flocculation reaction tank to generate sixth treated water; passing the sixth treated water through a seventh flocculation reaction tank to generate eighth treated water; and passing the eighth treated water through a second sedimentation tank to generate ninth treated water and sludge.

### CROSS-REFERENCE TO RELATED APPLICATION

This application is based on and claims priority under 35 U.S.C. § 119 to Korean Patent Application No. 10-2023-0117219, filed on Sep. 4, 2023, in the Korean Intellectual Property Office, the disclosure of which is incorporated by reference herein in its entirety.

### BACKGROUND

### 1. Field

Disclosed are a method and apparatus for treating wastewater. More specifically, disclosed are a method and apparatus for treating wastewater, which can achieve the effects of reducing the amount of chemicals used, reducing the amount of sludge generated, and not increasing a chlorine ion concentration.

### 2. Description of the Related Art

In conventional wastewater treatment technology, in order to remove fluorine, slaked lime and a chlorine-based fluorine remover are used, a pH of 8.5 or more is maintained by injecting the slaked lime, and the pH is neutralized using the chlorine-based fluorine remover.

Slaked lime is a chemical of which the solubility decreases as the pH increases, and as the operation is carried out at an increased pH, slaked lime must be added in an excess amount to meet the target water quality.

In conventional wastewater treatment technology, in order to effectively remove fluorine and phosphorus from wastewater containing fluorine and phosphorus, an excessive amount of slaked lime is added to the wastewater.

In addition, in order to remove fluorine, conventional wastewater treatment processes include a first flocculation-and-sedimentation process and a secondary flocculation-and-sedimentation process, and slaked lime and a chlorine-based fluorine remover are mainly used as chemicals.

However, when fluorine water quality standards become stricter, the conventional wastewater treatment technology can achieve the goal by increasing the amount of chemicals including slaked lime and a fluorine remover, but, as a result, imposes problems of causing side effects such as an increased amount of chemical used, an increased chlorine ion concentration, an increased amount of sludge generated, and decreased settleability.

### SUMMARY

One embodiment of the present invention provides a method for treating wastewater, which can achieve the effects of reducing the amount of chemicals used, reducing the amount of sludge generated, and not increasing a chlorine ion concentration.

Another embodiment of the present invention provides an apparatus for treating wastewater, which can achieve the effects of reducing the amount of chemicals used, reducing the amount of sludge generated, and not increasing a chlorine ion concentration.

Additional aspects will be set forth in part in the description which follows and, in part, will be apparent from the description, or may be learned by practice of the presented embodiments of the disclosure.

One aspect of the present invention provides a method for treating wastewater including
a first flocculation-and-sedimentation process and a second flocculation-and-sedimentation process that are carried out continuously,
wherein the first flocculation-and-sedimentation process comprises the steps of:
(S10-2) passing wastewater containing at least fluorine and phosphorus through a first flocculation reaction tank to generate first treated water;
(S10-4) passing the first treated water through a third flocculation reaction tank to generate third treated water;
(S10-6) passing the third treated water through a fourth flocculation reaction tank to generate fourth treated water; and
(S10-8) passing the fourth treated water through a first sedimentation tank to generate fifth treated water and sludge, and
the second flocculation-and-sedimentation process comprises the steps of:
(S20-2) passing the fifth treated water through a fifth flocculation reaction tank to generate sixth treated water;
(S20-4) passing the sixth treated water through a seventh flocculation reaction tank to generate eighth treated water; and
(S20-6) passing the eighth treated water through a second sedimentation tank to generate ninth treated water and sludge.

A first chemical may be added to the first flocculation reaction tank, the first chemical and a second chemical may be added to the third flocculation reaction tank, a third chemical may be added to the fourth flocculation reaction tank, the second chemical and a fourth chemical may be added to the fifth flocculation reaction tank, and the third chemical may be added to the seventh flocculation reaction tank.

The first chemical may include slaked lime, the second chemical may include a chlorine-based fluorine remover, the third chemical may include a polymer coagulant, and the fourth chemical may include an alkaline-based fluorine remover.

The chlorine-based fluorine remover may include aluminum chloride (AlCl₃), the polymer coagulant may include anionic polyacrylamide, sodium alginate, sodium polyacrylate, maleate copolymer, partial hydrolysate of polyacrylamide, or a combination thereof, and the alkaline-based fluorine remover may include sodium aluminate (NaAlO₂).

The pH of the first flocculation reaction tank may be adjusted to be in a range of 3.5 to 6.0, and the pH of the fifth flocculation reaction tank may be adjusted to be in a range of 6.5 to 7.5.

The pH of the third flocculation reaction tank can be adjusted to be in a range of 7.0±0.5.

The concentration of the third chemical in the fourth flocculation reaction tank may be adjusted to be in a range of 3.0±0.5 ppm, and the concentration of the third chemical in the seventh flocculation reaction tank may be adjusted to be in a range of 3.0±0.5 ppm.

The concentration of the second chemical in the third flocculation reaction tank may be adjusted to 800 to 1,700 ppm, and the concentration of the fourth chemical in the fifth flocculation reaction tank may be adjusted to 850 to 2,000 ppm.

The wastewater treatment method may further include a step of (S10-3) generating second treated water by passing the first treated water through a second flocculation reaction tank between the step (S10-2) and the step (S10-4), and in this case, the step (S10-4) may be a step of generating third treated water by passing the second treated water, instead of the first treated water, through the third flocculation reaction tank.

No chemicals may be separately added to the second flocculation reaction tank.

The wastewater treatment method may further include, between the step (S20-2) and the step (S20-4), a step of (S20-3) passing the sixth treated water through a sixth flocculation reaction tank to generate seventh treated water, and in this case, the step (S20-4) may be a step of generating eighth treated water by passing the seventh treated water, instead of the sixth treated water, through the seventh flocculation reaction tank.

No chemicals may be separately added to the sixth flocculation reaction tank.

Another aspect of the present invention provides an apparatus for treating wastewater, including
a first flocculation-and-sedimentation unit and a second flocculation-and-sedimentation unit that are connected in series with each other,
wherein the first flocculation-and-sedimentation unit comprises:
a first flocculation reaction tank configured to partially flocculate wastewater containing at least fluorine and phosphorus to generate first treated water;
a third flocculation reaction tank configured to additionally partially flocculate the first treated water to generate third treated water;
a fourth flocculation reaction tank configured to additionally partially flocculate the third treated water to generate fourth treated water; and
a first sedimentation tank configured to partially sediment the fourth treated water to generate fifth treated water and sludge, and the second flocculation-and-sedimentation unit comprises:
a fifth flocculation reaction tank configured to additionally partially flocculate the fifth treated water to generate sixth treated water;
a seventh flocculation reaction tank configured to additionally partially flocculate the sixth treated water to generate eighth treated water; and
a second sedimentation tank configured to partially sediment the eighth treated water to generate ninth treated water and sludge.

The first flocculation reaction tank may be configured to be operated in a pH range of 3.5 to 6.0, and the fifth flocculation reaction tank may be configured to be operated in a pH range of 6.5 to 7.5.

The third flocculation reaction tank may be configured to be operated in a pH range of 7.0±0.5.

The fourth flocculation reaction tank may be configured to be operated in a polymer coagulant concentration range of 3.0±0.5 ppm, and the seventh flocculation reaction tank may be configured to be operated in a polymer coagulant concentration range of 3.0±0.5 ppm.

The third flocculation reaction tank may be configured to be operated in a chlorine-based fluorine remover concentration range of 800 to 1,700 ppm, and the fifth flocculation reaction tank may be configured to be operated in an alkaline-based fluorine remover concentration range of 850 to 2,000 ppm.

The wastewater treatment apparatus may further include a second flocculation reaction tank configured, between the first flocculation reaction tank and the third flocculation reaction tank, to additionally partially flocculate the first treated water to generate second treated water, and in this case, the third flocculation reaction tank may be configured to additionally treat the second treated water, instead of the first treated water, to generate third treated water.

The wastewater treatment apparatus may further include a sixth flocculation reaction tank configured, between the fifth flocculation reaction tank and the seventh flocculation reaction tank, to additionally partially flocculate the sixth treated water to generate seventh treated water, and in this case, the seventh flocculation reaction tank may be configured to additionally treat the seventh treated water, instead of the sixth treated water, to generate eighth treated water.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 schematically shows a method and apparatus for treating wastewater, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a method for treating wastewater according to an embodiment of the present invention will be described in detail.

As used herein, the unit “ppm (parts per million)” means mg/L.

In addition, as used herein, “front end or front end portion” refers to a part or end portion that is located in the relatively reverse direction of the wastewater flow direction, and “rear end or rear end portion” refers to a part or end portion that is located in the relatively forward direction of the wastewater flow direction.

The wastewater treatment method and apparatus according to one embodiment of the present invention may remove fluorine, phosphorus, suspended solids (SS), organic matter, particulate matter, and ionic substances in wastewater.

The wastewater treatment method according to one embodiment of the present invention includes a first flocculation-and-sedimentation process and a second flocculation-and-sedimentation process that are carried out continuously.

The first flocculation-and-sedimentation process may include the steps of: (S10-2) passing wastewater containing at least fluorine and phosphorus through a first flocculation reaction tank to generate first treated water; (S10-4) passing the first treated water through a third flocculation reaction tank to generate third treated water; (S10-6) passing the third treated water through a fourth flocculation reaction tank to generate fourth treated water; and (S10-8) passing the fourth treated water through a first sedimentation tank to generate fifth treated water and sludge.

A first chemical may be added to the first flocculation reaction tank.

The first chemical may include slaked lime.

The pH of the first flocculation reaction tank can be adjusted to be in a range of 3.5 to 6.0. When the pH of the first flocculation reaction tank is within the range stated above, high-quality treated water with low fluorine concentration, phosphorus concentration, and chlorine ion concentration can be obtained, as well as the amount of sludge generated can be reduced.

The first chemical and a second chemical may be added to the third flocculation reaction tank.

The second chemical may include a chlorine-based fluorine remover.

The chlorine-based fluorine remover may contain aluminum chloride (AlCl₃).

The pH of the third flocculation reaction tank may be adjusted to be in a range of 7.0±0.5. When the pH of the third flocculation reaction tank is within the range stated above, high-quality treated water with low fluorine concentration, phosphorus concentration, and chlorine ion concentration can be obtained, as well as the amount of sludge generated can be reduced.

In addition, the concentration of the second chemical in the third flocculation reaction tank may be adjusted to 800 to 1,700 ppm. When the concentration of the second chemical in the third flocculation reaction tank is within the range stated above, high-quality treated water with low fluorine concentration, phosphorus concentration, and chlorine ion concentration can be obtained, as well as the amount of sludge generated can be reduced.

A third chemical may be added to the fourth flocculation reaction tank.

The third chemical may include a polymer coagulant.

The polymer coagulant may include anionic polyacrylamide, sodium alginate, sodium polyacrylate, maleate copolymer, partial hydrolysate of polyacrylamide, or a combination thereof.

The concentration of the third chemical in the fourth flocculation reaction tank may be adjusted to be in a range of 3.0±0.5 ppm. When the concentration of the third chemical in the fourth flocculation reaction tank is within the range stated above, high-quality treated water with low fluorine concentration, phosphorus concentration, and chlorine ion concentration can be obtained, as well as the amount of sludge generated can be reduced.

The wastewater treatment method may further include, between the step (S10-2) and the step (S10-4), a step (S10-3) passing the first treated water through a second flocculation reaction tank to generate second treated water. In this case, the step (S10-4) may be a step of generating third treated water by passing the second treated water, instead of the first treated water, through the third flocculation reaction tank. For example, the wastewater treatment method may include the step (S10-3) when the wastewater contains hydrogen peroxide, and may not include the step (S10-3) when the wastewater does not contain hydrogen peroxide or contains a negligibly small amount of hydrogen peroxide.

No chemicals may be separately added to the second flocculation reaction tank.

The second flocculation-and-sedimentation process may include the steps of: (S20-2) passing the fifth treated water through a fifth flocculation reaction tank to generate sixth treated water; (S20-4) passing the sixth treated water through a seventh flocculation reaction tank to generate eighth treated water; and (S20-6) passing the eighth treated water through a second sedimentation tank to generate ninth treated water and sludge.

The second chemical and a fourth chemical may be added to the fifth flocculation reaction tank.

The fourth chemical may include an alkaline-based fluorine remover.

The alkaline-based fluorine remover may include sodium aluminate (NaAlO₂).

The pH of the fifth flocculation reaction tank may be adjusted to be in a range of 6.5 to 7.5. When the pH of the fifth flocculation reaction tank is within the range stated above, high-quality treated water with low fluorine concentration, phosphorus concentration, and chlorine ion concentration can be obtained, as well as the amount of sludge generated can be reduced.

In addition, the concentration of the fourth chemical in the fifth flocculation reaction tank may be adjusted to 850 to 2,000 ppm. When the concentration of the fourth chemical in the fifth flocculation reaction tank is within the range stated above, high-quality treated water with low fluorine concentration, phosphorus concentration, and chlorine ion concentration can be obtained, as well as the amount of sludge generated can be reduced.

The third chemical may be added to the seventh flocculation reaction tank.

The concentration of the third chemical in the seventh flocculation reaction tank may be adjusted to be in a range of 3.0±0.5 ppm. When the concentration of the third chemical in the seventh flocculation reaction tank is within the range stated above, high-quality treated water with low fluorine concentration, phosphorus concentration, and chlorine ion concentration can be obtained, as well as the amount of sludge generated can be reduced.

The wastewater treatment method may further include, between the step (S20-2) and the step (S20-4), a step of (S20-3) passing the sixth treated water through a sixth flocculation reaction tank to generate seventh treated water. In this case, the step (S20-4) may be a step of generating eighth treated water by passing the seventh treated water, instead of the sixth treated water, through the seventh flocculation reaction tank. No chemicals may be separately added to the sixth flocculation reaction tank.

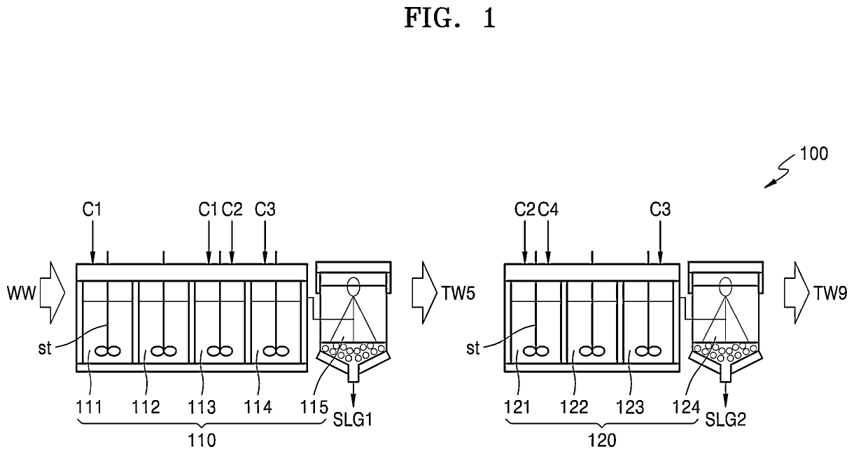

Hereinafter, a wastewater treatment apparatus 100 according to an embodiment of the present invention will be described in detail with reference to FIG. 1.

The wastewater treatment apparatus 100 according to one embodiment of the present invention includes a first flocculation-and-sedimentation unit 110 and a second flocculation-and-sedimentation unit 120 that are connected in series with each other.

The first flocculation-and-sedimentation unit 110 may include a first flocculation reaction tank 111, a third flocculation reaction tank 113, a fourth flocculation reaction tank 114, and a first sedimentation tank 115.

The first flocculation reaction tank 111 may be configured to treat wastewater WW containing at least fluorine and phosphorus to generate first treated water.

The first chemical C1 may be added to the first flocculation reaction tank 111.

The first flocculation reaction tank 111 may be configured to be operated in a pH range of 3.5 to 6.0. When the first flocculation reaction tank 111 is configured to be operated in the pH range stated above, high-quality treated water with low fluorine concentration, phosphorus concentration, and chlorine ion concentration can be obtained, as well as the amount of sludge generated can be reduced.

The third flocculation reaction tank 113 may be configured to additionally partially flocculate the first treated water to generate third treated water.

The first chemical C1 and the second chemical C2 may be added to the third flocculation reaction tank 113.

The third flocculation reaction tank 113 may be configured to be operated in a pH range of 7.0±0.5. When the third flocculation reaction tank 113 is configured to be operated in the pH range stated above, high-quality treated water with low fluorine concentration, phosphorus concentration, and chlorine ion concentration can be obtained, as well as the amount of sludge generated can be reduced.

In addition, the third flocculation reaction tank 113 may be configured to be operated at a chlorine-based fluorine remover concentration range of 800 to 1,700 ppm. When the third flocculation reaction tank 113 is configured to be operated within the chlorine-based fluorine remover concentration range stated above, high-quality treated water with low fluorine concentration, phosphorus concentration, and chlorine ion concentration can be obtained, as well as the amount of sludge generated can be reduced.

The fourth flocculation reaction tank 114 may be configured to additionally partially flocculate the third treated water to generate fourth treated water.

The third chemical C3 may be added to the fourth flocculation reaction tank 114.

The fourth flocculation reaction tank 114 may be configured to be operated in a polymer coagulant concentration range of 3.0±0.5 ppm. When the fourth flocculation reaction tank 114 is configured to be operated in the polymer coagulant concentration range of 3.0±0.5 ppm, high-quality treated water with low fluorine concentration, phosphorus concentration, and chlorine ion concentration can be obtained, as well as the amount of sludge generated can be reduced.

In addition, the wastewater treatment apparatus 100 according to one embodiment of the present invention may further include, between the first flocculation reaction tank 111 and the third flocculation reaction tank 113, a second flocculation reaction tank 112 configured to additionally partially flocculate the first treated water to generate second treated water. In this case, the third flocculation reaction tank 113 may be configured to additionally treat the second treated water, instead of the first treated water, to generate third treated water. For example, the wastewater treatment apparatus 100 may include the second flocculation reaction tank 112 when the wastewater contains hydrogen peroxide, and may not include the second flocculation reaction tank 112 when the wastewater does not contain hydrogen peroxide or contains a negligibly small amount of hydrogen peroxide.

No chemicals may be separately added to the second flocculation reaction tank 112.

The first sedimentation tank 115 may be configured to partially sediment the fourth treated water to generate fifth treated water TW5 and sludge SLG1.

The second flocculation-and-sedimentation unit 120 may include a fifth flocculation reaction tank 121, a seventh flocculation reaction tank 123, and a second sedimentation tank 124.

The fifth flocculation reaction tank 121 may be configured to additionally treat the fifth treated water TW5 to generate the sixth treated water.

The second chemical C2 and a fourth chemical C4 may be added to the fifth flocculation reaction tank 121.

The fifth flocculation reaction tank 121 may be configured to be operated in a pH range of 6.5 to 7.5. When the fifth flocculation reaction tank 121 is configured to be operated in the pH range stated above, high-quality treated water with low fluorine concentration, phosphorus concentration, and chlorine ion concentration can be obtained, as well as the amount of sludge generated can be reduced.

In addition, the fifth flocculation reaction tank 121 may be configured to be operated in an alkaline-based fluorine remover concentration range of 850 to 2,000 ppm. When the fifth flocculation reaction tank 121 is configured to be operated in the alkaline-based fluorine remover concentration range stated above, high-quality treated water with low fluorine concentration, phosphorus concentration, and chlorine ion concentration can be obtained, as well as the amount of sludge generated can be reduced.

The seventh flocculation reaction tank 123 may be configured to additionally partially flocculate the sixth treated water to generate eighth treated water.

The third chemical C3 may be added to the seventh flocculation reaction tank 123.

The seventh flocculation reaction tank 123 may be configured to be operated in a polymer coagulant concentration range of 3.0±0.5 ppm. When the seventh flocculation reaction tank 123 is configured to be operated in the polymer coagulant concentration range stated above, high-quality treated water with low fluorine concentration, phosphorus concentration, and chlorine ion concentration can be obtained, as well as the amount of sludge generated can be reduced.

In addition, the wastewater treatment apparatus 100 may further include, between the fifth flocculation reaction tank 121 and the seventh flocculation reaction tank 123, a sixth flocculation reaction tank 122 configured to additionally partially flocculate the sixth treated water to generate seventh treated water. In this case, the seventh flocculation reaction tank 123 may be configured to additionally treat the seventh treated water, instead of the sixth treated water, to generate eighth treated water.

The second sedimentation tank 124 may be configured to partially sediment the eighth treated water to generate ninth treated water TW9 and sludge SLG2.

In addition, the first flocculation reaction tank 111 to the seventh flocculation reaction tank 123 may each have a stirrer st mounted therein.

The wastewater treatment method and apparatus having the above described configuration according to an embodiment of the present invention may provide the effects of reducing the total amount of chemicals used by 60 wt %, reducing the amount of sludge generated by 20 wt %, and not increasing a chlorine ion concentration, compared existing technology.

Hereinafter, the present invention will be described in more detail through examples, but the present invention is not limited to these examples.

### Manufacture Example: Manufacture of Apparatus

A wastewater treatment apparatus having a configuration shown in FIG. 1 was manufactured.

The manufactured wastewater treatment apparatus includes a first flocculation-and-sedimentation unit and a second flocculation-and-sedimentation unit.

The first flocculation-and-sedimentation unit includes a first flocculation reaction tank, a second flocculation reaction tank, a third flocculation reaction tank, a fourth flocculation reaction tank, and a first sedimentation tank.

The second flocculation-and-sedimentation unit includes a fifth flocculation reaction tank, a sixth flocculation reaction tank, a seventh flocculation reaction tank, and a second sedimentation tank.

### Example 1: Operation of Wastewater Treatment Apparatus

As wastewater, semiconductor process wastewater having pH of 3.08, fluorine ion concentration (F) of 644 ppm, chlorine ion concentration (Cl) of 33.0 ppm, and PO₄-P of 160 ppm was used. Slaked lime is added to the first flocculation reaction tank, no chemicals are separately added to the second flocculation reaction tank, slaked lime and aluminum chloride (AlCl₃) are added to the third flocculation reaction tank, and anionic polyacrylamide is added to the fourth flocculation reaction tank. The content of slaked lime added to the first flocculation reaction tank is the amount in which the pH (R1-pH) of the first flocculation reaction tank is made to be maintained at 3.5. The content of aluminum chloride (AlCl₃) added to the third flocculation reaction tank is the amount in which the concentration (R3-C2) of aluminum chloride (AlCl₃) of the third flocculation reaction tank is made to be 1,250 ppm. The content of slaked lime added to the third flocculation reaction tank is the amount in which the pH (R3-pH) of the third flocculation reaction tank is made to be maintained at 7.0. The content of anionic polyacrylamide added to the fourth flocculation reaction tank is the amount in which the concentration (R4-C3) of anionic polyacrylamide of the fourth flocculation reaction tank is made to be 3 ppm. Aluminum chloride (AlCl₃) and sodium aluminate (NaAlO₂) are added to the fifth flocculation reaction tank, no chemicals are separately added to the sixth flocculation reaction tank, and anionic polyacrylamide is added to the seventh flocculation reaction tank. The content of sodium aluminate (NaAlO₂) added to the fifth flocculation reaction tank is the amount in which the concentration (R5-C4) of sodium aluminate (NaAlO₂) of the fifth flocculation reaction tank is made to be 1,425 ppm. The content of aluminum chloride (AlCl₃) added to the fifth flocculation reaction tank is the amount in which the pH (R5-pH) of the fifth flocculation reaction tank is made to be maintained at 7.0. The content of anionic polyacrylamide added to the seventh flocculation reaction tank is the amount in which the concentration (R7-C3) of anionic polyacrylamide of the seventh flocculation reaction tank is made to be 3 ppm.

### Example 2: Operation of Wastewater Treatment Apparatus

The wastewater treatment apparatus was operated in the same manner as in Example 1, except that the content of slaked lime added to the first flocculation reaction tank was changed to an amount in which the pH (R1-pH) of the first flocculation reaction tank was made to be maintained at 5.0.

### Example 3: Operation of Wastewater Treatment Apparatus

The wastewater treatment apparatus was operated in the same manner as in Example 1, except that the content of slaked lime added to the first flocculation reaction tank was changed to an amount in which the pH (R1-pH) of the first flocculation reaction tank was made to be maintained at 6.0.

### Example 4: Operation of Wastewater Treatment Apparatus

The wastewater treatment apparatus was operated in the same manner as in Example 2, except that the content of aluminum chloride (AlCl₃) added to the third flocculation reaction tank is the amount in which the concentration (R3-C2) of aluminum chloride (AlCl₃) of the third flocculation reaction tank was made to be 800 ppm.

### Example 5: Operation of Wastewater Treatment Apparatus

The wastewater treatment apparatus was operated in the same manner as in Example 2, except that the content of aluminum chloride (AlCl₃) added to the third flocculation reaction tank was changed to an amount in which the concentration (R3-C2) of aluminum chloride (AlCl₃) of the third flocculation reaction tank was made to be 1,700 ppm.

### Example 6: Operation of Wastewater Treatment Apparatus

The wastewater treatment apparatus was operated in the same manner as in Example 2, except that the content of sodium aluminate (NaAlO₂) added to the fifth flocculation reaction tank was changed to an amount in which the concentration (R5-C4) of sodium aluminate (NaAlO₂) of the fifth flocculation reaction tank is made to be 850 ppm.

### Example 7: Operation of Wastewater Treatment Apparatus

The wastewater treatment apparatus was operated in the same manner as in Example 2, except that the content of sodium aluminate (NaAlO₂) added to the fifth flocculation reaction tank was changed to an amount in which the concentration (R5-C4) of sodium aluminate (NaAlO₂) of the fifth flocculation reaction tank is made to be 2,000 ppm.

### Example 8: Operation of Wastewater Treatment Apparatus

The wastewater treatment apparatus was operated in the same manner as in Example 2, except that the content of aluminum chloride (AlCl₃) added to the fifth flocculation reaction tank was changed to an amount in which the pH (R5-pH) of the fifth flocculation reaction tank was made to be maintained at 6.5.

### Example 9: Operation of Wastewater Treatment Apparatus

The wastewater treatment apparatus was operated in the same manner as in Example 2, except that the content of aluminum chloride (AlCl₃) added to the fifth flocculation reaction tank was changed to an amount in which the pH (R5-pH) of the fifth flocculation reaction tank was made to be maintained at 7.5.

### Reference Example 1: Operation of Wastewater Treatment Apparatus

The wastewater treatment apparatus was operated in the same manner as in Example 1, except that the content of slaked lime added to the first flocculation reaction tank was changed to an amount in which the pH (R1-pH) of the first flocculation reaction tank was made to be maintained at 3.0.

### Reference Example 2: Operation of Wastewater Treatment Apparatus

The wastewater treatment apparatus was operated in the same manner as in Example 1, except that the content of slaked lime added to the first flocculation reaction tank was changed to an amount in which the pH (R1-pH) of the first flocculation reaction tank was made to be maintained at 7.0.

### Reference Example 3: Operation of Wastewater Treatment Apparatus

The wastewater treatment apparatus was operated in the same manner as in Example 2, except that the content of aluminum chloride (AlCl₃) added to the third flocculation reaction tank was changed to an amount in which the concentration (R3-C2) of aluminum chloride (AlCl₃) of the third flocculation reaction tank is made to be 600 ppm.

### Reference Example 4: Operation of Wastewater Treatment Apparatus

The wastewater treatment apparatus was operated in the same manner as in Example 2, except that the content of aluminum chloride (AlCl₃) added to the third flocculation reaction tank was changed to an amount in which the concentration (R3-C2) of aluminum chloride (AlCl₃) of the third flocculation reaction tank is made to be 1,900 ppm.

### Reference Example 5: Operation of Wastewater Treatment Apparatus

The wastewater treatment apparatus was operated in the same manner as in Example 2, except that the content of sodium aluminate (NaAlO₂) added to the fifth flocculation reaction tank was changed to an amount in which the concentration (R5-C4) of sodium aluminate (NaAlO₂) of the fifth flocculation reaction tank is made to be 750 ppm.

### Reference Example 6: Operation of Wastewater Treatment Apparatus

The wastewater treatment apparatus was operated in the same manner as in Example 2, except that the content of sodium aluminate (NaAlO₂) added to the fifth flocculation reaction tank was changed to an amount in which the concentration (R5-C4) of sodium aluminate (NaAlO₂) of the fifth flocculation reaction tank is made to be 2,100 ppm.

### Reference Example 7: Operation of Wastewater Treatment Apparatus

The wastewater treatment apparatus was operated in the same manner as in Example 2, except that the content of aluminum chloride (AlCl₃) added to the fifth flocculation reaction tank was changed to an amount in which the pH (R5-pH) of the fifth flocculation reaction tank was made to be maintained at 6.0.

### Reference Example 8: Operation of Wastewater Treatment Apparatus

The wastewater treatment apparatus was operated in the same manner as in Example 2, except that the content of aluminum chloride (AlCl₃) added to the fifth flocculation reaction tank was changed to an amount in which the pH (R5-pH) of the fifth flocculation reaction tank was made to be maintained at 8.0.

### Reference Example 9: Operation of Wastewater Treatment Apparatus

The wastewater treatment apparatus was operated in the same manner as in Example 2, except that the alum concentration (R3-C2′) of the third flocculation reaction tank was made to be maintained at 1,250 ppm by replacing aluminum chloride (AlCl₃) added to the third flocculation reaction tank with alum (Al₂(SO₄)₃).

### Reference Example 10: Operation of Wastewater Treatment Apparatus

The wastewater treatment apparatus was operated in the same manner as in Example 2, except that the slaked lime concentration (R5-C1) of the fifth flocculation reaction tank was made to be maintained at 1,425 ppm by replacing sodium aluminate (NaAlO₂) added to the fifth flocculation reaction tank with slaked lime.

The operating conditions (pH, chemical added amount, and chemical type) of the wastewater treatment apparatuses of Examples 1 to 9 and Reference Examples 1 to 10 are summarized and shown in Table 1 below.

TABLE 1

| | | | | | | Second flocculation-and- | | | |
|---|---|---|---|---|---|---|---|---|---|
| | First flocculation-and-sedimentation unit | | | | | sedimentation unit | | | |
| | | Third flocculation | | | | Fifth flocculation | | | |
| | | reaction tank | | | | reaction tank | | | |
| | | R3-C2 | R3-C2′ | | R4-C3 | R5-C4 | R5-C1 | | R7-C3 |
| | R1-pH | (ppm) | (ppm) | R3-pH | (ppm) | (ppm) | (ppm) | R5-pH | (ppm) |
| Example 1 | 3.5 | 1,250 | — | 7.0 | 3 | 1,425 | — | 7.0 | 3 |
| Example 2 | 5.0 | 1,250 | — | 7.0 | 3 | 1,425 | — | 7.0 | 3 |
| Example 3 | 6.0 | 1,250 | — | 7.0 | 3 | 1,425 | — | 7.0 | 3 |
| Example 4 | 5.0 | 800 | — | 7.0 | 3 | 1,425 | — | 7.0 | 3 |
| Example 5 | 5.0 | 1,700 | — | 7.0 | 3 | 1,425 | — | 7.0 | 3 |
| Example 6 | 5.0 | 1,250 | — | 7.0 | 3 | 850 | — | 7.0 | 3 |
| Example 7 | 5.0 | 1,250 | — | 7.0 | 3 | 2,000 | — | 7.0 | 3 |
| Example 8 | 5.0 | 1,250 | — | 7.0 | 3 | 1,425 | — | 6.5 | 3 |
| Example 9 | 5.0 | 1,250 | — | 7.0 | 3 | 1,425 | — | 7.5 | 3 |
| Reference | 3.0 | 1,250 | — | 7.0 | 3 | 1,425 | — | 7.0 | 3 |
| Example 1 | | | | | | | | | |
| Reference | 7.0 | 1,250 | — | 7.0 | 3 | 1,425 | — | 7.0 | 3 |
| Example 2 | | | | | | | | | |
| Reference | 5.0 | 600 | — | 7.0 | 3 | 1,425 | — | 7.0 | 3 |
| Example 3 | | | | | | | | | |
| Reference | 5.0 | 1,900 | — | 7.0 | 3 | 1,425 | — | 7.0 | 3 |
| Example 4 | | | | | | | | | |
| Reference | 5.0 | 1,250 | — | 7.0 | 3 | 750 | — | 7.0 | 3 |
| Example 5 | | | | | | | | | |
| Reference | 5.0 | 1,250 | — | 7.0 | 3 | 2,100 | — | 7.0 | 3 |
| Example 6 | | | | | | | | | |
| Reference | 5.0 | 1,250 | — | 7.0 | 3 | 1,425 | — | 6.0 | 3 |
| Example 7 | | | | | | | | | |
| Reference | 5.0 | 1,250 | — | 7.0 | 3 | 1,425 | — | 8.0 | 3 |
| Example 8 | | | | | | | | | |
| Reference | 5.0 | — | 1,250 | 7.0 | 3 | 1,425 | — | 7.0 | 3 |
| Example 9 | | | | | | | | | |
| Reference | 5.0 | 1,250 | — | 7.0 | 3 | — | 1,425 | 7.0 | 3 |
| Example 10 | | | | | | | | | |

### Evaluation Example: Performance Evaluation of Wastewater Treatment Apparatuses

The water quality of the final treated water (that is, treated water discharged from the second sedimentation tank) according to the operation of each of the wastewater treatment apparatuses in Examples 1 to 9 and Reference Examples 1 to 10, was evaluated, and the results are shown in Table 2 below.

TABLE 2

| | pH | F(ppm) | Cl(ppm) | PO₄—P(ppm) | Sludge (ml) |
|---|---|---|---|---|---|
| Example 1 | 6.5 | 0.63 | 584 | <0.3 | 100 |
| Example 2 | 6.5 | 0.40 | 581 | <0.3 | 100 |
| Example 3 | 6.5 | 0.44 | 593 | <0.3 | 100 |
| Example 4 | 6.5 | 0.63 | 554 | <0.3 | 100 |
| Example 5 | 6.5 | 0.43 | 587 | <0.3 | 100 |
| Example 6 | 6.5 | 0.63 | 554 | <0.3 | 100 |
| Example 7 | 6.5 | 0.32 | 712 | <0.3 | 150 |
| Example 8 | 6.0 | 0.32 | 572 | <0.3 | 150 |
| Example 9 | 6.7 | 0.52 | 568 | <0.3 | 100 |
| Reference | 6.5 | 3.93 | 555 | 1.9 | 100 |
| Example 1 | | | | | |
| Reference | 6.5 | 2.11 | 498 | <0.3 | 90 |
| Example 2 | | | | | |
| Reference | 6.5 | 1.27 | 520 | <0.3 | 90 |
| Example 3 | | | | | |
| Reference | 6.5 | 0.52 | 921 | <0.3 | 100 |
| Example 4 | | | | | |
| Reference | 6.5 | 2.85 | 357 | <0.3 | 70 |
| Example 5 | | | | | |
| Reference | 6.5 | 0.16 | 1082 | <0.3 | 280 |
| Example 6 | | | | | |
| Reference | 5.5 | 0.74 | 554 | <0.3 | 100 |
| Example 7 | | | | | |
| Reference | 6.8 | 1.15 | 507 | <0.3 | 120 |
| Example 8 | | | | | |
| Reference | 6.5 | 8.32 | 339 | <0.3 | 100 |
| Example 9 | | | | | |
| Reference | 6.5 | 1.53 | 473 | <0.3 | 80 |
| Example 10 | | | | | |

Referring to Table 2, the wastewater treatment apparatuses of Examples 1 to 9, were found to have superior quality of final treated water, compared to the wastewater treatment apparatuses of Reference Examples 1 to 10.

According to embodiments of the present invention, provided are a method and apparatus for treating wastewater, which can achieve the effects of reducing the amount of chemicals used by 60 wt %, reducing the amount of sludge generated by 20 wt %, and not increasing a chlorine ion concentration, compared existing technology.

While the present invention has been described with reference to the figures and embodiments, which have been presented by way of example only, and it will be appreciated by those skilled in the art that various changes and other equivalent embodiments may be made from the above description. Therefore, the true technical protection scope of the present invention should be defined by the inventive concept of the appended claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method for treating wastewater, the method comprising:
a first flocculation-and-sedimentation process and a second flocculation-and-sedimentation process that are carried out continuously, wherein
the first flocculation-and-sedimentation process comprises the steps of:
(S10-2) passing wastewater containing at least fluorine and phosphorus through a first flocculation reaction tank to generate first treated water;
(S10-4) passing the first treated water through a third flocculation reaction tank to generate third treated water;
(S10-6) passing the third treated water through a fourth flocculation reaction tank to generate fourth treated water; and
(S10-8) passing the fourth treated water through a first sedimentation tank to generate fifth treated water and sludge, and
the second flocculation-and-sedimentation process comprises the steps of:
(S20-2) passing the fifth treated water through a fifth flocculation reaction tank to generate sixth treated water;
(S20-4) passing the sixth treated water through a seventh flocculation reaction tank to generate eighth treated water; and
(S20-6) passing the eighth treated water through a second sedimentation tank to generate ninth treated water and sludge.

2. The method of claim 1, wherein a first chemical is added to the first flocculation reaction tank, the first chemical and a second chemical are added to the third flocculation reaction tank, a third chemical is added to the fourth flocculation reaction tank, the second chemical and a fourth chemical are added to the fifth flocculation reaction tank, and the third chemical is added to the seventh flocculation reaction tank.

3. The method of claim 1, wherein the first chemical includes slaked lime, the second chemical includes a chlorine-based fluorine remover, the third chemical includes a polymer coagulant, and the fourth chemical includes an alkaline-based fluorine remover.

4. The method of claim 3, wherein the chlorine-based fluorine remover includes aluminum chloride (AlCl₃), the polymer coagulant includes anionic polyacrylamide, sodium alginate, sodium polyacrylate, maleate copolymer, a partial hydrolysate of polyacrylamide, or a combination thereof, and the alkaline-based fluorine remover includes sodium aluminate (NaAlO₂).

5. The method of claim 3, wherein pH of the first flocculation reaction tank is adjusted to be in a range of about 3.5 to about 6.0, and pH of the fifth flocculation reaction tank is adjusted to be in a range of about 6.5 to about 7.5.

6. The method of claim 5, wherein pH of the third flocculation reaction tank is adjusted to be in a range of about 7.0±0.5.

7. The method of claim 6, wherein a concentration of the third chemical in the fourth flocculation reaction tank is adjusted to be in a range of about 3.0±0.5 ppm, and a concentration of the third chemical in the seventh flocculation reaction tank is adjusted to be in a range of about 3.0±0.5 ppm.

8. The method of claim 3, wherein a concentration of the second chemical in the third flocculation reaction tank is adjusted to about 800 to about 1,700 ppm, and a concentration of the fourth chemical in the fifth flocculation reaction tank is adjusted to about 850 to about 2,000 ppm.

9. The method of claim 1, further comprising, between the step (S10-2) and the step (S10-4), a step of (S10-3) generating second treated water by passing the first treated water through a second flocculation reaction tank, and in this case, the step (S10-4) is a step of generating third treated water by passing the second treated water, instead of the first treated water, through the third flocculation reaction tank.

10. The method of claim 9, wherein no chemicals are separately added to the second flocculation reaction tank.

11. The method of claim 1, further comprising, between the step (S20-2) and the step (S20-4), a step of (S20-3) passing the sixth treated water through a sixth flocculation reaction tank to generate seventh treated water, and in this case, the step (S20-4) is a step of generating eighth treated water by passing the seventh treated water, instead of the sixth treated water, through the seventh flocculation reaction tank.

12. The method of claim 11, wherein no chemicals are separately added to the sixth flocculation reaction tank.

13. An apparatus for treating wastewater, comprising:
a first flocculation-and-sedimentation unit and a second flocculation-and-sedimentation unit that are connected in series with each other,
wherein the first flocculation-and-sedimentation unit comprises:
a first flocculation reaction tank configured to partially flocculate wastewater containing at least fluorine and phosphorus to generate first treated water;
a third flocculation reaction tank configured to additionally partially flocculate the first treated water to generate third treated water;
a fourth flocculation reaction tank configured to additionally partially flocculate the third treated water to generate fourth treated water; and
a first sedimentation tank configured to partially sediment the fourth treated water to generate fifth treated water and sludge, and
the second flocculation-and-sedimentation unit comprises:
a fifth flocculation reaction tank configured to additionally partially flocculate the fifth treated water to generate sixth treated water;
a seventh flocculation reaction tank configured to additionally partially flocculate the sixth treated water to generate eighth treated water; and
a second sedimentation tank configured to partially sediment the eighth treated water to generate ninth treated water and sludge.

14. The apparatus of claim 13, wherein the first flocculation reaction tank is configured to be operated in a pH range of about 3.5 to about 6.0, and the fifth flocculation reaction tank is configured to be operated in a pH range of about 6.5 to about 7.5.

15. The apparatus of claim 14, wherein the third flocculation reaction tank is configured to be operated in a pH range of about 7.0±0.5.

16. The apparatus of claim 15, wherein the fourth flocculation reaction tank is configured to be operated in a polymer coagulant concentration range of about 3.0±0.5 ppm, and the seventh flocculation reaction tank is configured to be operated in a polymer coagulant concentration range of about 3.0±0.5 ppm.

17. The apparatus of claim 15, wherein the third flocculation reaction tank is configured to be operated in a chlorine-based fluorine remover concentration range of about 800 to about 1,700 ppm, and the fifth flocculation reaction tank is configured to be operated in an alkaline-based fluorine remover concentration range of about 850 to about 2,000 ppm.

18. The apparatus of claim 13, further comprising a second flocculation reaction tank disposed between the first flocculation reaction tank and the third flocculation reaction tank and configured to additionally partially flocculate the first treated water to generate second treated water, and in this case, the third flocculation reaction tank is configured to additionally treat the second treated water, instead of the first treated water, to generate third treated water.

19. The apparatus of claim 18, wherein no chemicals are separately added to the second flocculation reaction tank.

20. The apparatus of claim 13, further comprising a sixth flocculation reaction tank disposed between the fifth flocculation reaction tank and the seventh flocculation reaction tank and configured to additionally partially flocculate the sixth treated water to generate seventh treated water, and in this case, the seventh flocculation reaction tank is configured to additionally treat the seventh treated water, instead of the sixth treated water, to generate eighth treated water.

21. The apparatus of claim 20, wherein no chemicals are separately added to the sixth flocculation reaction tank.
